(19) United States
(12) Patent Application Publication
(10) Pub. No.: US 2012/0291740 A1
(43) Pub. Date: Nov. 22, 2012

(54) Coupling Device Between A Shaft And A Pulley And Engine Block Suitable For Being Installed In A Motor Vehicle

(75) Inventors: Michael Wascheul, Acheres (FR); Marc Giannoni, Paris (FR); Armel Le Lievre, Montesson (FR); Julien Berger, Paris (FR)

(73) Assignee: PEUGEOT CITROEN AUTOMOBILES SA, Velizy Villacoublay (FR)

(21) Appl. No.: 13/522,725

(22) PCT Filed: Feb. 2, 2011
(86) PCT No.: PCT/FR2011/050210

§ 371 Date: Jul. 18, 2012

(30) Foreign Application Priority Data
Feb. 9, 2010 (FR) 1050888

(51) Int. Cl. F16D 43/10; F02N 11/04

(52) U.S. Cl. 123/179.28; 192/105 R; 192/105 B

(57) ABSTRACT

The invention relates to a coupling device between a shaft (14) and a pulley (11) as well as to an engine block suitable for being installed in a motor vehicle. The shaft (14) and a pulley (11) can rotate relative to one another about an axis (15). According to the invention, the device includes a separate declutchable means (36, 37, 40, 42, 45, 50) for driving the shaft (14) by the pulley (11) only allowing the shaft (14) to be driven by the pulley (11) when the latter is rotating at a rotation speed that is higher than a predetermined rotation speed. The engine block includes a heat engine, a reversible alternator for starting the heat engine and generating electric power, an accessory, the heat engine and the reversible alternator being suitable for rotating the accessory by means of a belt. The engine block includes a coupling device according to the invention between an output shaft (14) of the heat engine and a pulley (11) driven by the belt (10).

### CROSS-REFERENCE TO RELATED APPLICATIONS

This application is the US National Stage under 36 U.S.C.§371 of International App. No. PCT/FR2011/050210 filed Feb. 2, 2011, and which claims priority to French App. No. 1050888 filed Feb. 9, 2010, which are hereby incorporated by reference.

### BACKGROUND

The invention relates to a coupling device between a shaft and a pulley and an engine block suitable for installation in an automotive vehicle and comprising a coupling device.

Automotive vehicles generally include several accessories that require an energy supply for their operation. The energy can be supplied by an electrical network of the vehicle or directly through the engine of the vehicle upstream of the transmission. For example, the combustion engine of the vehicle can drive the climate control assembly through the intermediary of a belt, often called a drive belt. The climate control assembly generally comprises a piston compressor driven by a rotating shaft. By supplying mechanical energy from the combustion engine to the shaft of the climate control assembly, there is no need for a dedicated electric motor to power the climate control assembly.

The drive belt associated with the combustion engine generally drives an electrical machine used as an alternator for supplying electrical energy to the electrical network of the vehicle. This electrical machine is reversible and used to start the combustion engine and is referred to as a reversible alternator.

The general trend is to limit the consumption of fossil fuels in automotive vehicles. For this purpose, hybrid vehicles have been developed with twin engines, such as a combustion engine and an electric motor supplied by batteries installed in the vehicle. The electric motor is used as long as the battery charge permits. However, the twin engine poses a problem for the supply of electrical energy to accessories such as the climate control assembly, when these accessories are driven by the drive belt. Indeed, the belt drive is only possible when the combustion engine is running. Therefore, the climate control assembly stops when the hybrid vehicle is powered by its electric motor.

The invention remedies this problem by disengaging the combustion engine from the drive belt and using a reversible alternator to drive the accessories, such as the climate control assembly, when the combustion engine is not running.

To this end, the invention is a coupling device between a shaft and a pulley, which rotate relative to each other around an axis, whereby the pulley surrounds the shaft. According to the invention, the coupling device comprises an independent disengagement device for driving the shaft through the pulley so that the driving of the shaft by the pulley is prohibited when the pulley runs at a rotational speed lower than a given rotational speed, while the driving of the shaft by the pulley is allowed when the pulley runs at a rotational speed greater than the given rotational speed.

Advantageously, the independent disengagement device comprises a clutch for connecting the shaft to the pulley through a coupling effect and at least one inertial mass that displaces radially relative to the axis during the rotation of the pulley. The displacement of the inertial mass generates a coupling force.

The coupling force is axially transmitted from the inertial mass to the clutch by a conical plate against which the inertial mass locates during its radial displacement. The terms axial and radial are relative to the axis of rotation of the pulley.

The device comprises a return spring opposing the coupling force and maintaining the clutch disengaged when the rotational speed of the pulley is lower than the given rotational speed.

According to another embodiment, the clutch is conical. This arrangement allows for high torque to be transmitted in a small volume.

To further increase the torque transmitted by the clutch, the clutch comprises several friction cones divided into two alternate assemblies. The first assembly rotationally connects with the pulley, and the second assembly rotationally connects with the shaft.

The invention also relates to an engine block suitable for installation in an automotive vehicle, which comprises a combustion engine, whereby a reversible alternator starts the combustion engine and generates electrical energy for an accessory, such as for instance a climate control assembly, and the combustion engine and the reversible alternator rotationally drive the accessory with a belt. The engine block comprises a coupling device according to the invention between the output shaft of the combustion engine and a pulley driven by the belt.

The foregoing and other features, and advantages of the disclosure as well as embodiments thereof will become more apparent from the reading of the following description in connection with the accompanying drawings.

### DESCRIPTION OF THE DRAWINGS

In the accompanying drawings which form part of the specification:

FIG. 1 is perspective view of a drive belt of an automotive vehicle and linked to several elements;

FIG. 2 is a section view of a disengageable coupling device between the pulley driven by the drive belt and a shaft; and

FIG. 3 is a perspective exploded view of the disengageable coupling device of FIG. 2.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its application to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

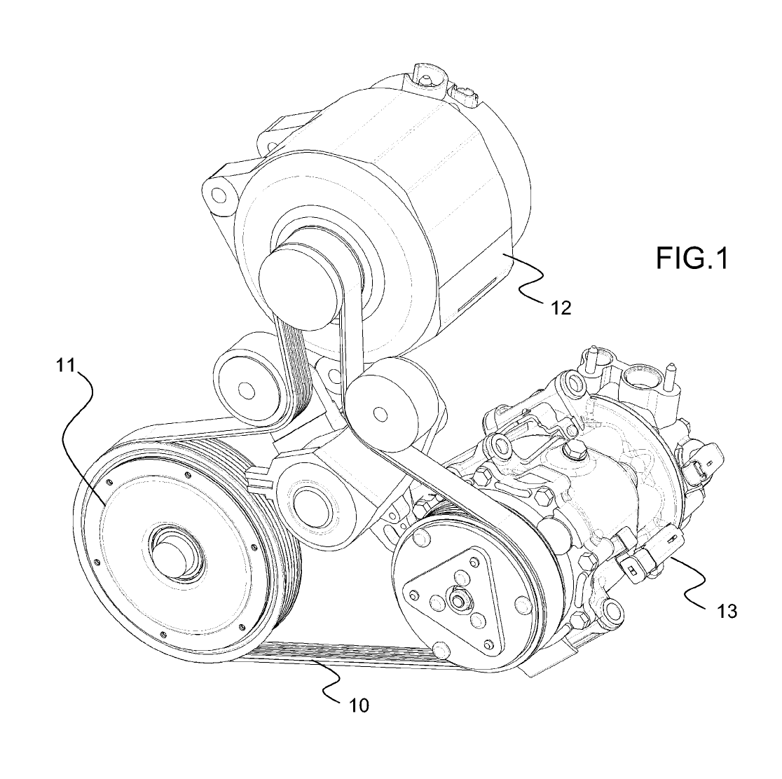

FIG. 1 shows a drive belt 10 of an automotive vehicle connected to several elements. The automotive vehicle comprises a combustion engine and a pulley 11 disposed at the end of the crankshaft of the combustion engine. Among the elements driven by belt 10, a reversible alternator 12 and a climate control assembly 13 are shown in FIG. 1, however, other accessories can also be driven by the belt 10.

The reversible alternator 12 can be used either as a starter to start the combustion engine, or as an alternator to supply the electrical network of the vehicle. For these two uses, the reversible alternator 12 and the combustion engine are permanently coupled. To this end, the pulley 11 connects to the crankshaft.

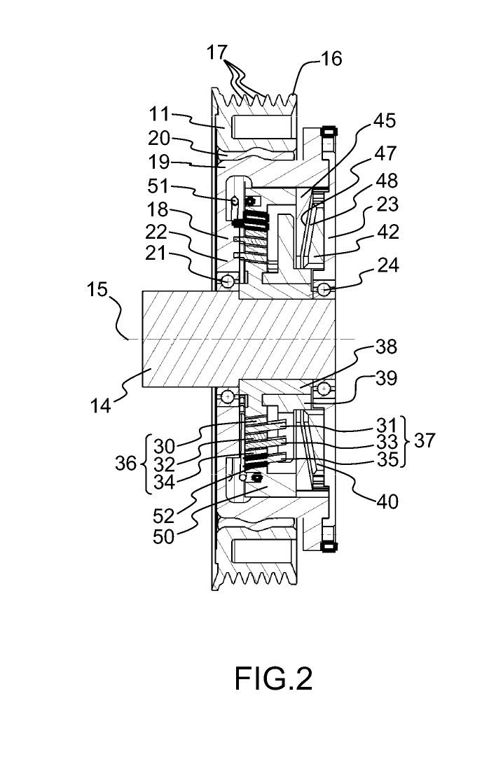

The invention allows the reversible alternator 12 to be used in another way for the transmission of mechanical power through the belt 10, even when the combustion engine is not running. To this end, pulley 11 is disengageable. FIG. 2 shows a cross-section of the coupling device of pulley 11 and visually displays an independent disengagement device of the crankshaft through belt 10. One free end of the crankshaft constitutes a shaft 14 which rotates freely around an axis 15. The pulley 11 either spins freely relative to shaft 14 or rigidly connects with it. The invention provides an independent disengagement device for the driving shaft 14 through the pulley 11. The rotational connection between pulley 11 and shaft 14 is obtained for a rotational speed of the pulley 11 around axis 15 greater than a given speed. Below this speed, the pulley 11 freely rotates relative to the shaft 14. The reversible alternator 12 can be electrically supplied to the drive pulley 11 through the intermediary of the belt 10 at a speed greater than the given speed and start the combustion engine. The reversible alternator 12 can be electrically supplied so that the rotational speed of pulley 11 is lower than the given speed, to keep the pulley 11 freely rotating relative to shaft 14 and not starting the combustion engine. No exterior action is required to obtain the engagement or disengagement of shaft 14 and pulley 11. The rotation of pulley 11 alone causes the engagement or disengagement. The given rotational speed is, for instance, 1500 revolutions per minute (or 157 radians per second in the international system). Below this speed, the combustion engine is not connected to pulley 11. On the other hand, above this speed, the crankshaft and the pulley are connected.

Pulley 11 comprises a revolution surface 16 intended to receive the belt 10. To increase the mechanical energy transmitted between the belt 10 and the pulley 11, the belt 10 includes grooves and the revolution surface 16 defines several grooves 17 which correspond to the grooves of belt 10. The pulley 11 comprises a rim 18 of which one exterior peripheral part 19 connects with the surface 16. An elastic liner 20 inserts between the exterior peripheral part 19 and the surface 16 to filter any asynchronous occurrences in the rotation of pulley 11 or in the rotation of shaft 14. A ball bearing 21 connects the central part 22 of rim 18 and shaft 14. Rim 18 forms a first lateral face of pulley 11. A second lateral face of pulley 11 forms by a closing plate 23 which connects with the exterior peripheral part 19. A second ball bearing 24 connects the closing plate 23 and shaft 14. The two ball bearings 21 and 24 form the bearings around which pulley 11 rotates relative to shaft 14 around axis 15.

The independent disengagement device for driving shaft 14 through pulley 11 is housed in a space situated between rim 18 and closing plate 23. This space is limited radially by the exterior peripheral part 19 of rim 18. The independent disengagement device comprises a clutch for connecting shaft 14 with pulley 11. For instance, the clutch is conical and comprises several friction cones 30 to 35 divided in two alternate assemblies. A first assembly 36 comprising cones 30, 32 and 34 rotationally connects with rim 18. A second assembly 37 comprising cones 31, 33 and 35 rotationally connects with shaft 14 through the intermediary of a hub 38 and a cross-piece 39, both connect with shaft 14. Cross-piece 39 allows for rotational connection of assembly 37 relative to shaft 14 around axis 13, while leaving a degree of freedom in translation according to axis 13. Due to this degree of freedom in translation, the two assemblies 36 and 37 frictionally contact each other to ensure power transmission between shaft 14 and pulley 11. To ensure a high friction coefficient between the two assemblies 36 and 37, cones 30 to 35 can be made of carbon or be coated with carbon.

The independent disengagement device comprises at least one inertial mass moves radially relative to the axis 15 during the rotation of pulley 11. In the example shown, four inertial masses 40 to 43 are present and two are visible on FIG. 2. The masses 40 to 43 are distributed radially around axis 13. The inertial masses 40 to 43 are rotationally driven by pulley 11, through the intermediary of then closing plate 23 around axis 15. When the pulley 11 rotates, masses 40 to 43 move in translation radially relative to axis 15 until they come in contact with plate 45, which is a body of revolution around axis 15. Masses 40 to 43 are all identical in order to move simultaneously under the effect of the rotation of pulley 11. Plate 45 is free to translate according to axis 15. The movement of the plate is guided by the exterior peripheral part 19 of rim 18. The plate 45 comprises a conical surface 46 which seats against another conical surface 48 belonging to each of the inertial masses 40 to 43. This contact between the two conical surfaces 47 and 48 transforms the radial force exercised by the masses during their movement in an axial effort resulting in the coupling of shaft 14 and pulley 11.

The conical plate 45 seats against a pressure plate 50, which is a body of revolution, free in translation relative to the rim 18. The device comprises a return spring 51 opposing the axial coupling force. The spring 51 rests against the rim 18 on one side and pushes against the pressure plate 50 on the other side. The calibration of spring 51 allows for regulation of the given rotational speed of pulley 11 beyond which coupling takes place. In other words, the return spring 51 keeps the clutch disengaged when the rotational speed of pulley 11 is lower than the given rotational speed.

The pressure plate comprises a conical surface 52 intended to seat against the friction cone 35. When the force exercised against the conical plate 45 by the inertial masses 40 to 43 is sufficient to compress spring 51, the friction cones 30 to 35 press against each other and connect the pulley 11 with the shaft 14.

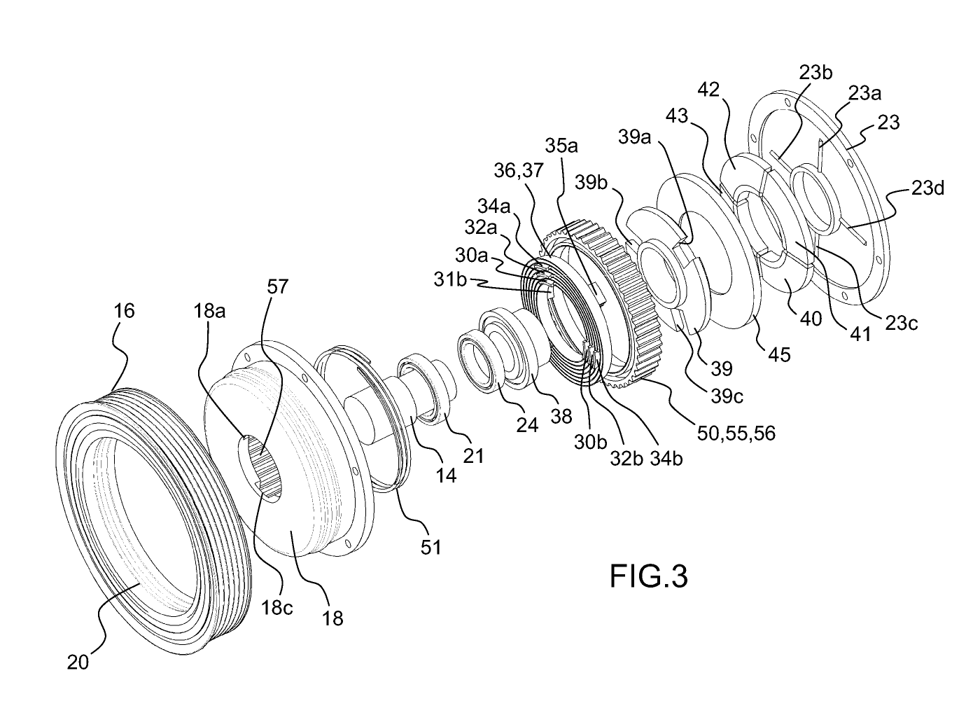

FIG. 3 shows an exploded view in perspective of the disengageable coupling device, where the axial guiding of pressure plate 50 defines grooves 55 arranged on an exterior cylindrical surface 56 of the pressure plate and corresponding grooves 57 on an interior cylindrical surface of rim 18. Alternatively, other guiding means are possible, such as a system using a key mounted on the pressure plate 50 which can slide in a slot made in rim 18. We distinguish also the rotational driving of cones 30, 32 and 34 by rim 18. Each of the cones 30, 32 and 34 disposes of several fingers 30a, 30b and 30c for cone 30, 32a 32b and 32c for cone 32 and 34a for 34b and 34c for cone 34. These fingers cooperate with corresponding slots 18a, 18b and 18c made in rim 18. Similarly, fingers are made in cones 31, 33 and 35. These fingers cooperate with grooves 39a, 39b and 39c of cross-piece 39 to ensure the rotational driving of cones 31, 33 and 35. In FIG. 3, all fingers are not visible. For the same cone, they are regularly distributed around axis 13. The same applies to the slots. The masses 40 to 43 are rotationally driven by closing plate 23 through radial abutments 23a, 23b, 23c and 23d made in projecting manner in closing plate 23. Each of the inertial masses 40 to 43 is guided in its radial displacement between two of these radial abutments. For instance, mass 41 moves radially along closing plate 23 while remaining confined between radial abutments 23a and 23d.

Changes can be made in the above constructions without departing from the scope of the disclosure, it is intended that all matter contained in the above description or shown in the accompanying drawings shall be interpreted as illustrative and not in a limiting sense.

1. A coupling device between a shaft and a pulley which turn relative to each other around an axis, whereby the pulley surrounds the shaft; comprising:
an independent disengagement device for driving the shaft through the pulley, which interdict the driving of the shaft through the pulley when the pulley rotates at a speed lower than a given rotational speed and allow the shaft to be driven by the pulley when the pulley rotates at a rotational speed greater than the given speed.

2. The coupling device according to claim 1, wherein the independent disengagement device comprises:
a clutch allowing for the coupling of the shaft relative to the pulley under the effect of a coupling force and at least one inertial mass that displaces radially relative to the axis during the rotation of the pulley and in that the displacement of the inertial mass generates the coupling force.

3. The coupling device according to claim 2, wherein the coupling force axially transmits from the inertial mass to the clutch through a conical plate against which the inertial mass seats during its radial displacement.

4. The coupling device according to claim 3, further comprising, a return spring opposing the coupling force and maintaining the clutch disengaged when the rotational speed of the pulley is lower than the given rotational speed.

5. The coupling device according to claim 2, wherein the clutch is conical.

6. The coupling device according to claim 5, wherein the clutch comprises several friction cones divided into two alternate assemblies, whereby a first assembly (36) rotationally connects with the pulley and a second assembly rotationally connects with the shaft.

7. An engine block suitable for installation in an automotive vehicle comprising:
a combustion engine;
a reversible alternator allowing for the start of the combustion engine and the generation of electrical energy; and
an accessory, whereby the combustion engine and the reversible alternator rotationally drive the accessory with a belt, a coupling device between an output shaft of the combustion engine and a pulley driven by the belt.

8. The engine block according to claim 7, wherein the accessory is a climate control assembly.
